(19) United States
(12) Patent Application Publication
(10) Pub. No.: US 2016/0245634 A1
(43) Pub. Date: Aug. 25, 2016

(54) Method and Apparatus for Relating Measurements with Comparable Objects for the Purpose of Recording Evidence

(71) Applicant: Jarrod C. Burns, Rosenberg, TX (US)

(72) Inventor: Jarrod C. Burns, Rosenberg, TX (US)

(73) Assignee: BSC FORENSICS, Rosenberg, TX (US)

(21) Appl. No.: 14/808,665

(22) Filed: Jul. 24, 2015

Related U.S. Application Data
(60) Provisional application No. 62/119,808, filed on Feb. 24, 2015.

(51) Int. Cl. G01B 3/02

(52) U.S. Cl. CPC G01B 3/02

(57) ABSTRACT

The invention is a method and measuring device configured for measurement by comparing the an area of interest or object with an object of comparable size and/or shape. This invention may be most useful when recording and classifying evidence. The measuring device should be portable and comprised of a flat, straight elongated member with measuring indicia along one or both the measuring edges, wherein the measuring indicia corresponds with values with labels of the standard sizes of comparable objects. The measuring indicia extends along the length of the measuring edge and the labels indicate the closest sized object. Other measuring indicia along the length of the measuring edge may also correspond to standard measurement units. The method should directly correlate a measurement with a comparable object for the purpose of recording evidence.

### CROSS-REFERENCE TO OTHER APPLICATIONS

The present disclosure claims priority to provisional patent application 62/119,808

### BACKGROUND OF THE INVENTION

The present disclosure relates generally to measuring devices and methods and, more particularly, to a method and apparatus for measuring by comparing an area or object of interest by relating that area or object of interest with an object of comparable size and/or shape.

Field studies are conducted in a variety of industries where evidence must be recorded and measured. Often, for classification purposes or for description purposes, it is useful to compare the evidence size to comparable, common, everyday objects. In certain industries, this becomes particularly important where the evidence cannot be collected or handled, increasing the necessity for thorough and descriptive measurements. When the evidence cannot be directly collected or handled for later, more thorough examination or reporting, the area may sometimes be photographed or described in writing. Certain industries, in particular, come to mind that find accuracy in measurements to be of particular importance: the law enforcement industry or the insurance industry. These measurements used for evidence collection may impact people's lives, livelihoods, or cost them or the insurance company a large amount of money if not done properly or thoroughly. The people taking the measurements may not be able to directly collect evidence, but may instead choose to record the evidence for later classification, study, reporting, or presenting. Some instances where this may be the case would be where large surfaces on streets, houses, or cars may be impacted by a small object like a bullet or a weather-related phenomena like hail, although these examples are not meant to be limiting.

Although the measurers in the industries mentioned and in any other instance when measurements for the purpose of recording information is necessary, may train to assess damage or may train to record evidence, current industry standards rely heavily on visual assessments. Even where there are tools or methods available, those tools are often inconvenient or expensive and do not directly relate the measurements to the result. In many of these situations, the original area or object measured cannot be assessed easily at a later date to verify the information because the site is unavailable or transitory. Therefore, the area or object should be measured accurately and appropriately recorded or described initially so that whoever is assessing, referring to, or being presented the recorded evidence is able to draw important and more accurate conclusions, or is better able to understand the scope. This becomes even more important where the results and conclusions drawn from such evidence recording impacts important aspects of people's lives and livelihoods and where slight variations in standard measurements could result in differing conclusions.

The purpose or end goal of many individuals measuring an area or object is to correlate or compare that area or object with another comparable object. In the case of law enforcement or crime scene technicians, they may be assessing impact damage to correlate it with bullet caliber or an area spattered with blood or some other fluid correlated to a common object for easier classification and assessment. In the case of insurance adjusters or people wanting to claim damage to an insurance company, they may be assessing damage to correlate it with a standard hail size. For hail, for instance, it is already common practice to associate levels of damage with the sizes of common, everyday objects. There are other industries and situations where the recording of evidence through comparison of a measurement with a comparable object would aid people in their ability to carry out their purpose or meet their goals. In any case, it would be advantageous to be able to correlate the area or object measured more directly with a correlatable, common object.

When making measurements, the person measuring, or the “measurer,” could look at the following factors: size, the shape, and in some cases a related angle—any or all of which could affect the measurement of an area of interest or object. Size and shape are more easily discernible, but angle may have importance where an object strikes a surface, and the area struck is being measured. Sometimes an object is being inferred from a measurement. For instance, if an object is thought to have caused damage, but that object is not available at the time of the investigation, then the measurements taken may be used to infer what object caused the damage. In the case of weather-related phenomenon, the weather phenomenon may have dissipated or melted at the time of investigation. In other cases, the object may be hidden or lost. In the case of fluids spattered against a surface, the fluids may wash away with time and are difficult to capture. Therefore, indirect measurements become necessary for the proper classification and recordation of evidence, even in cases where the object or area may be available, to provide corroborating evidence. The use of current devices or methods could lead to discrepancies or errors in measurement or recording leading to compounding error that may be introduced.

Currently, although some tools and methods may be limitedly available, most people do not have access to these tools, may find them cumbersome, or the tools and methods may leave room for inaccurate measurements. Often, the current standard practice is to use a combination of visual approximations, memory, and a measuring tape or ruler.

Therefore, there exists a need in these industries and probably others for a more direct, efficient, and portable method and device in order to correlate measurements with comparable objects for the purposes of recording and classifying evidence.

### SUMMARY OF THE INVENTION

The present invention relates to a portable measuring device or measuring method for correlating an area of interest or object with a comparable, common object. The measuring device, comprising a flat, straight, elongated body graduated with measuring indicia on at least one measuring edge extending along a finite length of device. The measuring indicia comprises values with a plurality of labels corresponding to the sizes of comparable objects with which to compare the area of interest or object. The labels correspond to comparable objects and enable a measurer to compare the measurement to known objects when evaluating, recording and/or photographing evidence thereby facilitating the assessment and classification of that evidence. The measuring method comprises the steps of placing a measuring tool on or next to an area of interest or object and recording the measurement taken in a manner that can be assessed or reviewed later in time, where the information recorded relates the measurement taken to a common object.

The measuring device may additionally include measuring indicia on a measuring edge extending along a finite length of the device with labels corresponding to American or Metric units.

The measuring device may additionally comprise a two axes chart pivotally mounted on the device or placed directly on the device for determining an angle of impact. This chart would be similar to a logarithmic chart, using measurement of the length and width of an impacted surface, and correlating those measurements with an approximate angle of impact.

A complete understanding of the invention will be obtained from the following description when taken in connection with the accompanying drawing figures wherein like reference characters identify like parts throughout. However, these embodiments should not be construed as limitations on the scope of any embodiment, but as exemplifications of various embodiments thereof. Many other variations are possible within the teachings of the various embodiments. Thus, the scope should be determined by the appended claims and their equivalents, and not by the examples given.

### BRIEF DESCRIPTION OF DRAWINGS

FIG. 1 is a plan view of the measuring device comprising measuring indicia with labels representing reference sizes of known objects corresponding to standard hail sizes.

FIG. 2 is a plan view of the measuring device comprising measuring indicia with labels representing reference bullet calibers.

FIG. 3 illustrates an example of a federal standard hail size comparison chart from the National Oceanic and Atmospheric Administration.

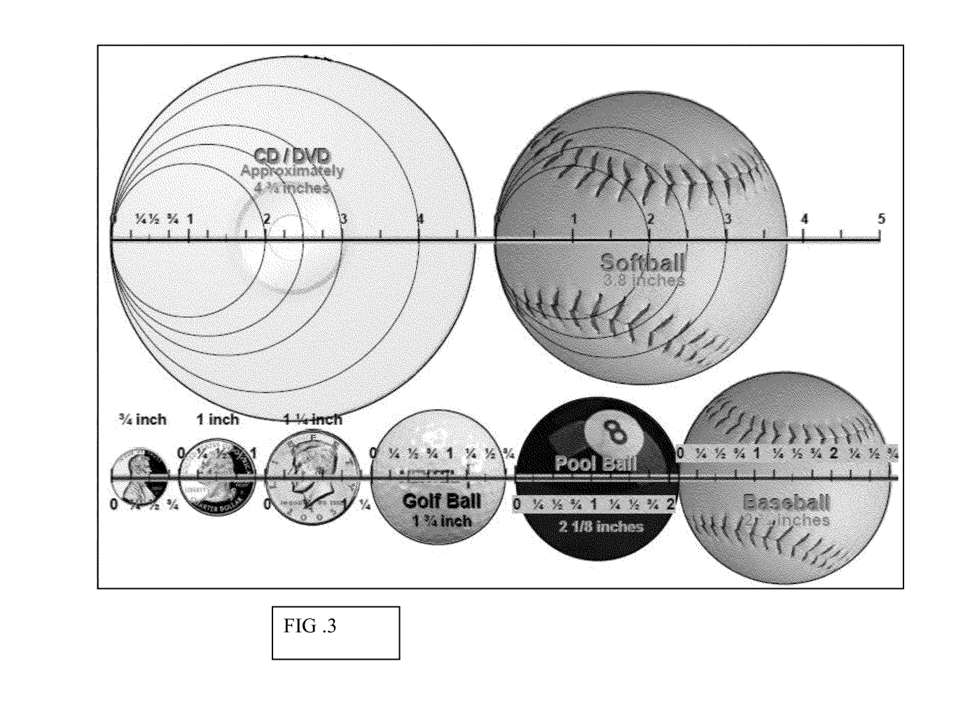

### DETAILED DESCRIPTION OF THE INVENTION

For a thorough understanding of the present disclosure, reference is to be made to the following detailed description. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the present disclosure. Further, it will nevertheless be understood that no limitation in the scope of the disclosure is thereby intended, such alterations and further modifications in the figures and such further applications of the principles of the disclosure, as illustrated therein being contemplated as would normally occur to one skilled in the art to which the disclosure relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the disclosure. Furthermore, the appearances of such phrase at various places herein are not necessarily all referring to the same embodiment. The terms “a” and “an” herein do not denote a limitation of quantity, but rather denote the presence of at least one of the referenced item.

The present disclosure provides a device and method for measurement by comparing an area of interest or object to a comparable object for the purpose of recording evidence. The present disclosure's tool and the method for using such tool allows measurers to more directly, accurately, and efficiently make a measurement, particularly where there are few portable tools available to the measurer. An example of the use of proposed measuring device could be, an individual who runs out after a storm to assess the damage to his or her roof or car. Another example could be an insurance adjuster who has been asked to investigate the validity of an insurance claim who must infer the size of the hailstones and also the angle by measuring a variety of surfaces damaged by hail and record those measurements and sizes for evaluation. The last example given, though there could be many other instances where a surface is not struck, could be a law enforcement professional or crime scene technician who must determine the caliber of a bullet from an impacted surface for the purpose of recording or classifying the evidence for further investigation.

Currently, measurers use a combination of visual approximations, memory, and a traditional measuring tape or ruler to later correlate measurements with an object or a classification category. As in the above examples, the classification and recording of these measurements could have great impact on other people and on investigations. Therefore, relying on measurements that are later classified, visual approximations, and memory might not only lead to inaccuracy in the measurement or the inference, but also inaccuracy in the classification of the evidence collected. In conclusion, there are many circumstances at which human error may distort the accuracy of the information measured and/or recorded. Therefore, a new tool or method that could eliminate some sources of error could allow for the more direct, efficient and accurate measurement.

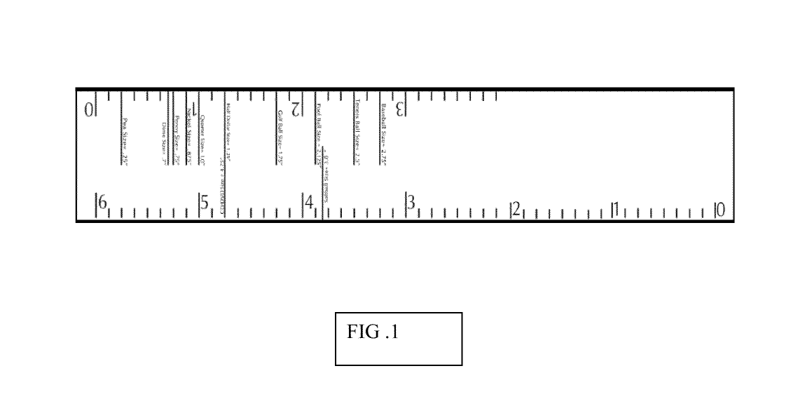

Referring to FIG. 1, illustrates a plan view of a measuring device comprising measuring indicia with labels representing reference sizes of known objects corresponding to standard hail sizes. The measuring device is planar, comprising a flat, straight and elongated body with measuring indicia on at least one measuring edge, which extends along a finite length of device. This allows for ease and comfort while being used, as it resembles a traditional ruler or other rectangular object. The measuring indicia could have both the traditional “inch” or “centimeter” measurement markers found on a common purpose ruler and/or measurement markers that correspond with a federal standard such as the National Oceanic and Atmospheric Administration's standard sizes for hail or ice (Table 1). In an embodiment, the device may only have the measurement markers corresponding to standard hail or ice sizes. The measuring indicia allows for direct correlation of the impacted area with standard hail sizes in the field with a single tool, thereby reducing the risk of error when recording evidence.

TABLE 1

Measurement

| Hailstone size | In. | cm. |
|---|---|---|
| bb | <¼ | <0.64 |
| Pea | ¼ | 0.64 |
| Dime | 7/10 | 1.8 |
| Penny | ¾ | 1.9 |
| Nickel | ⅞ | 2.2 |
| Quarter | 1 | 2.5 |
| Half dollar | 1¼ | 3.2 |
| Golf ball | 1¾ | 4.4 |
| Billiard ball | 2⅛ | 5.4 |
| Tennis ball | 2½ | 6.4 |
| Baseball | 2¾ | 7.0 |
| Softball | 3.8 | 9.7 |
| Compact disc/DVD | 4¾ | 12.1 |

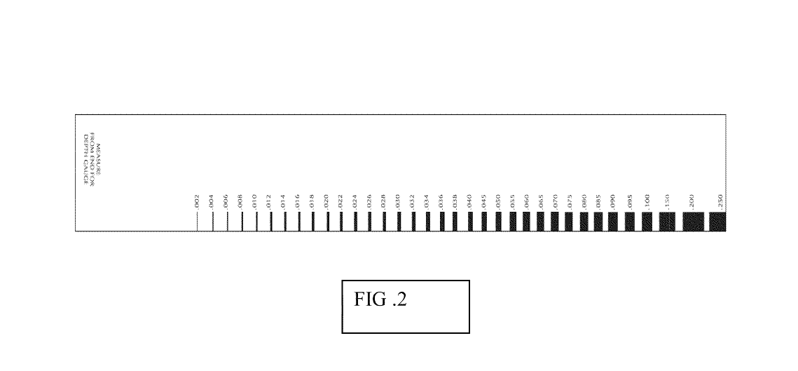

FIG. 2 illustrates a plan view of a measuring device comprising measuring indicia with labels representing reference sizes of bullet calibers. The measuring device is planar, comprising a flat, straight and elongated body with measuring indicia on at least one measuring edge, which extends along a finite length of device. This allows for ease and comfort while being used, as it could resemble a traditional ruler or other rectangular object. The measuring indicia could have both the traditional “inch” or “centimeter” measurement markers found on a common purpose ruler and/or measurement markers that correspond with common bullet calibers. In an embodiment, the device may only have the measurement markers corresponding to bullet calibers. The measuring indicia allows impacted areas to be directly correlated with an object in the field with a single tool, thereby reducing the risk of error when recording evidence.

In another embodiment, the measuring device may also comprise a chart directly printed on the measuring device or pivotally mounted to the elongated member, in an area and of a size that would not obscure the measuring indicia printed along at least one of the edges. The chart comprises a two axes chart, which is used to correlate the measured length and width of the area of impact with an angle of impact. The angle of impact can be mathematically estimated and displayed in a numeric or graphical manner, wherein the graphical chart may comprise a logarithmic scale. . The chart may be printed, displayed in a graphical manner, could pivot from the main body of the elongated member and placed on the impacted area to correlate the height and width in order to determine the angle of impact.

The measuring device of the present invention is portable and is useful while recording evidence, especially evidence that cannot easily be collected for later classification or examination. In an embodiment, the measuring device is of a finite length, not exceeding eight inches in length. The lightweight and hand-held structural dimensions aid in easy mobility, usage and storage. The device may be constructed using a rigid or non-rigid material and may be of a square or rectangular shape. In an embodiment, the device may be constructed of a transparent material to aid in measurement of an impacted surface by allowing a clear line of sight through the device to the surface or object to be measured.

In another embodiment, the device comprises an additional set of measuring indicia extending along a second measuring edge of a finite length. The measuring indicia may comprise measuring marks graduated in metric units or American units or SI units or its combinations in a linear scale. An embodiment may have measuring indicia graduated with numerical fractional values. The measuring edges may comprise similar or different scales of measurement.

In an exemplary embodiment, the measuring device comprises a ruler like body graduated with numerical measurements in inches. The device comprises two measuring edges with linearly marked indicia, but in opposite directions allowing versatile usability. The measuring indicia comprises a plurality of markings that are equally spaced apart and marked perpendicular to the axis of the ruler till a finite length that is appropriate for the type of damage being recorded or the industry for which the evidence is being collected is reached. The measuring indicia further comprises a plurality of labels representing comparably sized objects.

The method comprises of two main steps. In the first step, a tool is used to measure an area of interest or object, where the tool directly correlates the area of interest or object to a common, comparable object instead of only to a numerical measurement. In the second step, that measurement and comparison to a common, comparable object is recorded that allows for later viewing or examination.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure. For example, some alternative embodiments have been suggested to exemplify the versatility of the present disclosure but others may also be contemplated.

Preferred embodiments are described herein, including the best mode known to the inventor. Of course, variations of those preferred embodiments will become apparent to those of ordinary skill in the art upon reading the foregoing description. The inventor expects skilled artisans to employ such variations as appropriate. Moreover, any combination of the above-described elements in all possible variations thereof is encompassed unless otherwise indicated herein or otherwise clearly contradicted by context.

What is claimed is:

1. A measuring device configured to aid in recording evidence comprising:
an flat, straight elongated member with at least one measuring edge of a finite length; and
a measuring indicia, extending along the length of the measuring edge comprising values with labels corresponding to objects of a comparable size.

2. The measuring device as claimed in claim 1, where said finite length is less than or equal to eight inches.

3. The measuring device as claimed in claim 1, where said objects of a comparable size vary as appropriate for the evidentiary needs of the industry.

4. The measuring device as claimed in claim 1, further comprises an additional set of measuring indicia with corresponding labels referencing American or metric units for said finite length.

5. The measuring device as claimed in claim 1, where said measuring device is constructed from a transparent material.

6. The measuring device as claimed in claim 1, where said measuring device is constructed from a non-rigid material.

7. The measuring device as claimed in claim 1, where said measuring device is constructed from a rigid material.

8. A device for measuring surfaces impacted by an object or substance, the device comprising:
an elongated member comprising at least one measuring edge with a finite length; and
at least one set of measuring indicia extending along the length of said at least one measuring edge, comprising values with labels corresponding to objects of a comparable size.

9. The device as claimed in claim 8, where said finite length is less than or equal to eight inches.

10. The device as claimed in claim 8, where said objects of a comparable size vary as appropriate for he evidentiary needs of the industry.

11. The device as claimed in claim 8, where an additional said set of measuring indicia with corresponding labels located adjacent to and extending along a length of one said measuring edge include equally spaced American or metric units.

12. The device as claimed in claim 8, where said measuring device is constructed of a transparent material.

13. The measuring device as claimed in claim 12, where said measuring device is constructed from a rigid material.

14. The measuring device as claimed in claim 12, where said measuring device is constructed from a non-rigid material.
